(19) United States
(12) Patent Application Publication
(10) Pub. No.: US 2007/0076237 A1
(43) Pub. Date: Apr. 5, 2007

(54) Image Input/Output Control Device, Network System and Program

(75) Inventor: Yasuhiro Kudo, Ichinomiya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/534,712

(22) Filed: Sep. 25, 2006

(30) Foreign Application Priority Data
Sep. 30, 2005 (JP) 2005287408

(51) Int. Cl. G06F 3/12

(52) U.S. Cl. 358/1.13; 358/1.15; 358/400

(57) ABSTRACT

An image input/output control device comprises: a first acquisition unit which acquires information on image input processing capabilities of each image input device from each image input device via a network; a second acquisition unit which acquires information on image output processing capabilities of each image output device from each image output device via the network; a selection unit which selects an image input device and an image output device of equivalent image input/output processing capabilities based on the information on the processing capabilities of each image input device acquired by the first acquisition unit and the information on the processing capabilities of each image output device acquired by the second acquisition unit; and a control unit which operates the image input device and the image output device selected by the selection unit via the network as one image input/output device.

### CROSS-REFERENCE TO RELATED APPLICATION

This application claims priority under 35 U.S.C. §119 from Japanese Patent Application No. 2005-287408, filed on Sep. 30, 2005. The entire subject matter of the application is incorporated herein by reference.

### BACKGROUND

1. Technical Field

The present invention relates to an image input/output control device which is used in a network including one or more image input devices (e.g. scanners) and a plurality of image output devices (e.g. printers) for properly selecting and combining devices to be used for image input and output from the image input/output devices and properly operating the combined devices, a network system which is provided with the image input/output control device, and a program for operating a computer as the image input/output control device.

2. Related Art

Control devices for integrated management of a scanner and a plurality of printers connected to a network have widely been known. Such a control device disclosed in Japanese Patent Provisional Publication No. 2000-78342 is configured to acquire status information on a printer's sheet supply stage and sheet ejection stage (specifically, normality/abnormality of a sheet supply system and a sheet ejection system, the number of sheet supply trays, the sheet size regarding each sheet supply tray, the number of sheets stack up in each sheet supply tray, the largest number of sheets that can be stored in each sheet supply tray, etc.) from each printer via a network and to display the status of the sheet supply stages and sheet ejection stages of the printers connected to the network on a display device based on the acquired status information as if status of only one printer is being displayed on the display device.

The control device is capable of displaying a screen regarding the sheet supply stages and sheet ejection stages. When a user of the control device designates necessary information (a sheet supply stage and a sheet ejection stage to be used for the printing of image data obtained by the scanner by image scanning, the number of copies, etc.) on the screen, a printer corresponding to the designation is selected automatically and copy control using the scanner and the selected printer is executed.

### SUMMARY

Aspects of the present invention which has been made in consideration of the above problems is advantageous in that an image input/output control device, a network system and a program, realizing easy selection of an image output device optimum for image output (output of image data obtained by an image input device) when an image input device (e.g. scanner) and one of a plurality of image output devices (e.g. printers) connected to a network are combined and used for image input and output, can be provided.

### BRIEF DESCRIPTION OF THE ACCOMPANYING DRAWINGS

FIG. 1 is a block diagram showing the overall composition of a network system in accordance with an embodiment of the present invention.

FIG. 2 is a block diagram showing the configuration of a control unit of a FAX machine included in the network system of FIG. 1.

FIG. 3 is a block diagram showing the configuration of a printer included in the network system of FIG. 1.

FIG. 4 is a flow chart showing the operation of each device (scanner, printer) connected to the network.

FIG. 5A is an explanatory drawing showing an example of an advertisement packet multicasted by each device (scanner, printer) for announcing its connection to the network.

FIG. 5B is an explanatory drawing showing an example of an advertisement packet multicasted by each device (scanner, printer) for announcing its disconnection from the network.

FIG. 5C is an explanatory drawing showing an example of a search packet multicasted by the FAX machine for searching for devices on the network.

FIG. 5D is an explanatory drawing showing an example of a response packet transmitted (unicasted) by a device receiving the search packet of FIG. 5C.

FIG. 6 is a flow chart showing a process executed by the control unit of the FAX machine for controlling the scanners and printers on the network.

FIG. 7 is an explanatory drawing showing an example of the result of an virtual MFP group formation process executed in the process of FIG. 6 (virtual MFP group list).

FIG. 8 is a flow chart showing a process executed by a WWW terminal 6 included in the network system when a user of the WWW terminal uses the FAX machine or checks an output image of the FAX machine.

FIG. 9 is a flow chart showing the virtual MFP group formation process executed by the control unit of the FAX machine.

FIG. 10 is a flow chart showing a concrete example of a scoring process executed in S690 of FIG. 9.

FIG. 11A is an explanatory drawing showing an example of a device information request message transmitted by the FAX machine for acquiring device information.

FIG. 11B is an explanatory drawing showing an example of XML data describing the device information.

FIG. 12A is an explanatory drawing showing an example of a device attribute information request message transmitted by the FAX machine for acquiring attribute information.

FIG. 12B is an explanatory drawing showing an example of a device attribute information response message acquired in response to the device attribute information request message.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

In accordance with an aspect of the present invention, there is provided an image input/output control device which is connected to a network (to which a plurality of image input devices of different processing capabilities and a plurality of image output devices of different processing capabilities are connected) for selectively combining one of the image input devices with one of the image output devices and operating the combined image input device and image output device as one image input/output device. The image input/output control device comprises: a first acquisition unit which acquires information on image input processing capabilities of each image input device from each image input device via the network; a second acquisition unit which acquires information on image output processing capabilities of each image output device from each image output device via the network; a selection unit which selects an image input device and an image output device of equivalent image input/output processing capabilities based on the information on the processing capabilities of each image input device acquired by the first acquisition unit and the information on the processing capabilities of each image output device acquired by the second acquisition unit; and a control unit which operates the image input device and the image output device selected by the selection unit via the network as one image input/output device.

In the image input/output control device configured as above, an image input device and an image output device of equivalent image processing capabilities (resolution, color/monochrome compatibility, etc.) are selected by the selection unit from the one or more image input devices and the plurality of image output devices connected to the network based on the information on the processing capabilities of each image input device and each image output device acquired by the first and second acquisition units, and the image input device and the image output device selected by the selection unit are operated by the control unit via the network as one image input/output device.

Therefore, the user is allowed to use a combination of an image input device and an image output device of equivalent image processing capabilities (resolution, color/monochrome compatibility, etc.) without the need of manually selecting the combination of devices to be used for image input and output, by which the user is prevented from selecting and using an unsuitable combination of an image input device and an image output device (e.g. erroneously selecting an image output device unsuitable for outputting an input image obtained by an image output device).

Here, the “equivalent image processing capabilities” (of the image input device and image output device selected by the selection unit) means that the input image obtained by the image input device can be outputted by the image output device as an output image without deteriorating the image quality of the input image.

When an image output device achieving the exact “equivalence” (causing no deterioration of image quality) can not be found on the network, the selection unit may regard (select) one of the image output devices on the network causing the least deterioration of image quality as the image output device of equivalent image processing capabilities (i.e. image output device of image processing capabilities equivalent to the image input device).

For example, taking the resolution as an example of the processing capabilities, the selection unit may regard (select) an image output device capable of outputting the output image in the same resolution as the input image (obtained by the image input device) as the image output device of equivalent image processing capabilities when such an image output device exists on the network. When such an image output device (capable of outputting the output image in the same resolution as the input image) does not exist on the network, the selection unit may regard (select) an image output device capable of outputting the output image in a higher resolution nearest to that of the input image as the image output device of equivalent image processing capabilities. When there is no image output device capable of outputting the output image in the same resolution as the input image nor in a resolution higher than that of the input image, the selection unit may regard (select) an image output device capable of outputting the output image in a lower resolution nearest to that of the input image as the image output device of equivalent image processing capabilities.

However, the processing capabilities of the image input device and image output device can include not only the resolution but also various parameters such as processable image color (color/monochrome compatibility), color system and image size. When the image input device and image output device of equivalent processing capabilities are selected based on such multiple parameters, the selection unit may be configured to score (evaluate) the equivalence or compatibility between each image input device and each image output device in regard to each of the parameters and select a combination of an image input device and an image output device achieving the highest total score (the sum of the scores regarding the parameters) as the image input device and image output device of equivalent processing capabilities.

In at least one aspect, the image input/output control device further comprises a server unit which operates as a WWW server on the network. The control unit receives image data from the image input device selected by the selection unit according to HTTP by use of the server unit and transmits the received image data to the image output device selected by the selection unit according to HTTP by use of the server unit.

In the image input/output control device configured as above, the image data is communicated between the selected image input device and the selected image output device according to HTTP. By the communication of the image data between the selected image input device and the selected image output device according to a common protocol, the devices can be operated as one image input/output device.

In at least one aspect, the image input/output control device further comprises a device information acquisition unit which acquires device information on each image input device and each image output device connected to the network by use of a multicast packet requesting the device information. The first acquisition unit and the second acquisition unit recognize the number of image input devices connected to the network, the number of image output devices connected to the network, and the processing capabilities of each image input device and each image output device based on the device information acquired by the device information acquisition unit.

In the image input/output control device configured as above, the device information acquisition unit acquires the device information on each image input device and each image output device connected to the network by use of the multicast packet. Therefore, the user does not have to input address information, etc. on the image input devices and image output devices connected to the network. In other words, the image input/output control device is capable of recognizing the number of image input devices connected to the network, the number of image output devices connected to the network, and the processing capabilities of each image input device and each image output device upon its connection to the network. The user is relieved of the need of making settings for the operation of the image input/output control device, by which high usability is realized.

In at least one aspect, the selection unit sets a plurality of groups each of which is formed by an image input device and an image output device of equivalent image input/output processing capabilities and lets a user select one of the groups. The control unit operates the image input device and the image output device forming the selected group as one image input/output device.

In the image input/output control device configured as above, a plurality of groups (each of which is formed by an image input device and an image output device connected to the network of equivalent image input/output processing capabilities) are set based on the image processing capabilities of each device, and the user is allowed to select one of the groups. Thus, when the user selects a desired image input device or image output device, an image output device or image input device equivalent to the selected device (i.e. an image output device or image input device of the lowest processing capabilities enough to be compatible with the selected device) is selected automatically and the user is allowed to carry out the image input and output in desired image quality by use of the selected devices.

In at least one aspect, the first acquisition unit acquires the information on the image input processing capabilities of each image input device in regard to each of a plurality of purposes of image data. The second acquisition unit acquires the information on the image output processing capabilities of each image output device in regard to each of the purposes. The selection unit makes the selection of an image input device and an image output device of equivalent image input/output processing capabilities in regard to each of the purposes based on the information on the processing capabilities of each image input device acquired by the first acquisition unit in regard to each of the purposes and the information on the processing capabilities of each image output device acquired by the second acquisition unit in regard to each of the purposes.

In the image input/output control device configured as above, the selection of an image input device and an image output device of equivalent image input/output processing capabilities is made by the selection unit in regard to each of a plurality of purposes (color purpose, monochrome purpose, high resolution purpose, low resolution purpose, photo purpose, document purpose, etc.) based on the information on the processing capabilities of each image input device acquired by the first acquisition unit in regard to each of the purposes and the information on the processing capabilities of each image output device acquired by the second acquisition unit in regard to each of the purposes. Therefore, a combination of an image input device and an image output device optimum for inputting and outputting an image of a particular type (corresponding to a particular purpose or combination of purposes) can be selected automatically and the image can be processed (inputted and outputted) in an optimum state.

The above image input/output control device does not necessarily be configured only for the control function. Specifically, the image input/output control device may further comprise at least one of an image input device and an image output device built in the image input/output control device.

In other words, the image input/output control device may be provided with a scanner unit as a built-in image input device or a printer unit as a built-in image output device, or may also be configured as a copier provided with both a scanner unit and a printer unit.

In the image input/output control device configured as above, not only the image input devices and image output devices connected to the network but also the built-in image input device and/or built-in image output device can be selected for a combination by the selection unit and operated by the control unit as one image input/output device, by which the image input/output device can be operated in various combinations and the image input/output can be executed in various ways.

In at least one aspect, the control unit transmits image data acquired from the image input device to a terminal device which is connected to the network and capable of displaying images, according to an instruction from outside to let the terminal device display an image according to the image data.

In the image input/output control device configured as above, image data acquired from the image input device can be displayed by the terminal device on the network. Therefore, the user can check the image data (input image from the image input device) on a screen of the terminal device before letting the image output device output the input image.

In at least one aspect, the image input/output control device further comprises a transmission unit which transmits image data to an external receiving terminal via an external network. The control unit transmits image data acquired from the image input device to an external receiving terminal via the transmission unit according to an instruction from outside.

In the image input/output control device configured as above, the transmission unit built in the image input/output control device is capable of transmitting image data acquired from the image input device to an external receiving terminal (FAX machine, MFP (Multi Function Peripheral), etc.) via an external network (the Internet, a public telephone circuit, etc.) as needed. Thus, not only the image input/output but also image data transmission (e.g. FAX transmission) can be implemented.

In accordance with another aspect of the present invention, there is provided an image input/output control device which is connected to a network to which at least one image input device having a plurality of purposes and a plurality of image output devices of different processing capabilities are connected, for selectively combining the at least one image input device with one of the image output devices and operating the combined image input device and image output device as one image input/output device. The image input/output control device comprises: a first acquisition unit which acquires information on processing capabilities of the at least one image input device in regard to each of a plurality of purposes of image data; a second acquisition unit which acquires information on processing capabilities of each image output device; a selection unit which selects an image input device and an image output device of equivalent image input/output processing capabilities in regard to each of the purposes based on the information on the processing capabilities of each image input device acquired by the first acquisition unit in regard to each of the purposes and the information on the processing capabilities of each image output device acquired by the second acquisition unit; and a control unit which operates the image input device and the image output device selected by the selection unit via the network as one image input/output device.

In the image input/output control device configured as above, an image input device and an image output device of equivalent image input/output processing capabilities is selected by the selection unit in regard to each of a plurality of purposes (color purpose, monochrome purpose, high resolution purpose, low resolution purpose, photo purpose, document purpose, etc.) based on the information on the processing capabilities of each image input device acquired by the first acquisition unit in regard to each of the purposes and the information on the processing capabilities of each image output device acquired by the second acquisition unit in regard to each of the purposes. Therefore, a combination of an image input device and an image output device optimum for inputting and outputting an image of a particular type (corresponding to a particular purpose or combination of purposes) can be selected automatically and the image can be processed (inputted and outputted) in an optimum state.

In at least one aspect, the image input/output control device further comprises a server unit which operates as a WWW server on the network. The control unit receives image data from the image input device selected by the selection unit according to HTTP by use of the server unit and transmits the received image data to the image output device selected by the selection unit according to HTTP by use of the server unit.

In at least one aspect, the at least one image input device comprises a plurality of image input devices, and the image input/output control device further comprises a device information acquisition unit which acquires device information on each image input device and each image output device connected to the network by use of a multicast packet requesting the device information. The first acquisition unit and the second acquisition unit recognize the number of image input devices connected to the network, the number of image output devices connected to the network, and the processing capabilities of each image input device and each image output device based on the device information acquired by the device information acquisition unit.

In at least one aspect, at least one image input device comprises a plurality of image input devices, and the selection unit sets a plurality of groups, each of which is formed by an image input device and an image output device of equivalent image input/output processing capabilities, in regard to each of the purposes and lets a user select one of the groups. The control unit operates the image input device and the image output device forming the selected group as one image input/output device.

The above image input/output control device does not necessarily be configured only for the control function. Specifically, the image input/output control device may further comprise at least one of an image input device and an image output device built in the image input/output control device.

In at least one aspect, the control unit transmits image data acquired from the at least one image input device to a terminal device which is connected to the network and capable of displaying images, according to an instruction from outside to let the terminal device display an image according to the image data.

In at least one aspect, the image input/output control device further comprises a transmission unit which transmits image data to an external receiving terminal via an external network. The control unit transmits image data acquired from the at least one image input device to an external receiving terminal via the transmission unit according to an instruction from outside.

In accordance with another aspect of the present invention, there is provided a network system comprising: a plurality of image input devices of different processing capabilities connected to a network; a plurality of image output devices of different processing capabilities connected to the network; and an image input/output control device connected to the network. The image input/output control device includes: a first acquisition unit which acquires information on image input processing capabilities of each image input device from each image input device via the network; a second acquisition unit which acquires information on image output processing capabilities of each image output device from each image output device via the network; a selection unit which selects an image input device and an image output device of equivalent image input/output processing capabilities based on the information on the processing capabilities of each image input device acquired by the first acquisition unit and the information on the processing capabilities of each image output device acquired by the second acquisition unit; and a control unit which operates the image input device and the image output device selected by the selection unit via the network as one image input/output device.

In the network system configured as above, an image input device and an image output device of equivalent image processing capabilities (resolution, color/monochrome compatibility, etc.) are selected by the selection unit of the image input/output control device from the one or more image input devices and the plurality of image output devices connected to the network based on the information on the processing capabilities of each image input device and each image output device acquired by the first and second acquisition units, and the image input device and the image output device selected by the selection unit are operated by the control unit of the image input/output control device via the network as one image input/output device.

Therefore, the user is allowed to use a combination of an image input device and an image output device of equivalent image processing capabilities (resolution, color/monochrome compatibility, etc.) without the need of manually selecting the combination of devices to be used for image input and output, by which the user is prevented from selecting and using an unsuitable combination of an image input device and an image output device (e.g. erroneously selecting an image output device unsuitable for outputting an input image obtained by an image output device).

In at least one aspect, the network system further comprises a terminal device which is connected to the network and capable of displaying images. The control unit of the image input/output control device sends image data acquired from the image input device to the terminal device according to an instruction from outside to let the terminal device display an image according to the image data.

In the network system configured as above, image data acquired from the image input device can be displayed by the terminal device on the network. Therefore, the user can check the image data (input image from the image input device) on a screen of the terminal device before letting the image output device output the input image.

For example, when the image input device is a scanner, the user can check whether the input image obtained by the scanner by image scanning is a desired image or not (i.e. whether a scanning error, etc. has occurred or not) before the output of the input image by the image output device.

Incidentally, the “image input devices” in the present invention can include not only devices like scanners (for scanning an image on an object (e.g. paper) and thereby generating image data) but also image capturing devices like digital cameras (for capturing an image of a subject and thereby generating image data), devices for reading image data from a record medium (CD, DVD, etc.), etc.

In at least one aspect, the network system further comprises a transmission device which is built in the image input/output control device or connected to the network and capable of transmitting image data to an external receiving terminal via an external network. The control unit of the image input/output control device transmits image data acquired from the image input device to an external receiving terminal by use of the transmission device according to an instruction from outside.

In the network system configured as above, image data acquired from the image input device can not only be outputted by an image output device suitable for the image input device but also be transmitted to an external receiving terminal (FAX machine, MFP, etc.) via the transmission device and an external network (the Internet, a public telephone circuit, etc.) as needed. Thus, not only the image input/output but also image data transmission (e.g. FAX transmission) can be implemented by use of the transmission device.

In accordance with another aspect of the present invention, there is provided a network system comprising: at least one image input device having a plurality of purposes connected to a network; a plurality of image output devices of different processing capabilities connected to the network; and an image input/output control device connected to the network. The image input/output control device includes: a first acquisition unit which acquires information on processing capabilities of the at least one image input device in regard to each of a plurality of purposes of image data; a second acquisition unit which acquires information on processing capabilities of each image output device; a selection unit which selects an image input device and an image output device of equivalent image input/output processing capabilities in regard to each of the purposes based on the information on the processing capabilities of the at least one image input device acquired by the first acquisition unit in regard to each of the purposes and the information on the processing capabilities of each image output device acquired by the second acquisition unit in regard to each of the purposes; and a control unit which operates the image input device and the image output device selected by the selection unit via the network as one image input/output device.

In the network system configured as above, an image input device and an image output device of equivalent image input/output processing capabilities is selected by the selection unit of the image input/output control device in regard to each of a plurality of purposes (color purpose, monochrome purpose, high resolution purpose, low resolution purpose, photo purpose, document purpose, etc.) based on the information on the processing capabilities of each image input device acquired by the first acquisition unit in regard to each of the purposes and the information on the processing capabilities of each image output device acquired by the second acquisition unit in regard to each of the purposes. Therefore, a combination of an image input device and an image output device optimum for inputting and outputting an image of a particular type (corresponding to a particular purpose or combination of purposes) can be selected automatically and the image can be processed (inputted and outputted) in an optimum state.

In at least one aspect, the network system further comprises a terminal device which is connected to the network and capable of displaying images. The control unit of the image input/output control device sends image data acquired from the at least one image input device to the terminal device according to an instruction from outside to let the terminal device display an image according to the image data.

In at least one aspect, the network system further comprises a transmission device which is built in the image input/output control device or connected to the network and capable of transmitting image data to an external receiving terminal via an external network. The control unit of the image input/output control device transmits image data acquired from the at least one image input device to an external receiving terminal by use of the transmission device according to an instruction from outside.

In accordance with another aspect of the present invention, there is provided a computer program product comprising computer-readable instructions that cause a computer to function as: a first acquisition unit which acquires information on image input processing capabilities of each image input device from each image input device connected to a network; a second acquisition unit which acquires information on image output processing capabilities of each image output device from each image output device connected to the network; a selection unit which selects an image input device and an image output device of equivalent image input/output processing capabilities based on the information on the processing capabilities of each image input device acquired by the first acquisition unit and the information on the processing capabilities of each image output device acquired by the second acquisition unit; and a control unit which operates the image input device and the image output device selected by the selection unit via the network as one image input/output device.

In accordance with another aspect of the present invention, there is provided a computer program product comprising computer-readable instructions that cause a computer to function as: a first acquisition unit which acquires information on processing capabilities of at least one image input device connected to a network in regard to each of a plurality of purposes of image data; a second acquisition unit which acquires information on processing capabilities of each image output device connected to the network; a selection unit which selects an image input device and an image output device of equivalent image input/output processing capabilities in regard to each of the purposes based on the information on the processing capabilities of the at least one image input device acquired by the first acquisition unit in regard to each of the purposes and the information on the processing capabilities of each image output device acquired by the second acquisition unit; and a control unit which operates the image input device and the image output device selected by the selection unit via the network as one image input/output device.

With the computer program products configured as above, a computer connected to a network can be operated as the image input/output control devices described above, by which effects similar to those of the image input/output control devices can be achieved.

### Embodiment

Referring now to the drawings, a description will be given in detail of a preferred embodiment in accordance with the present invention.

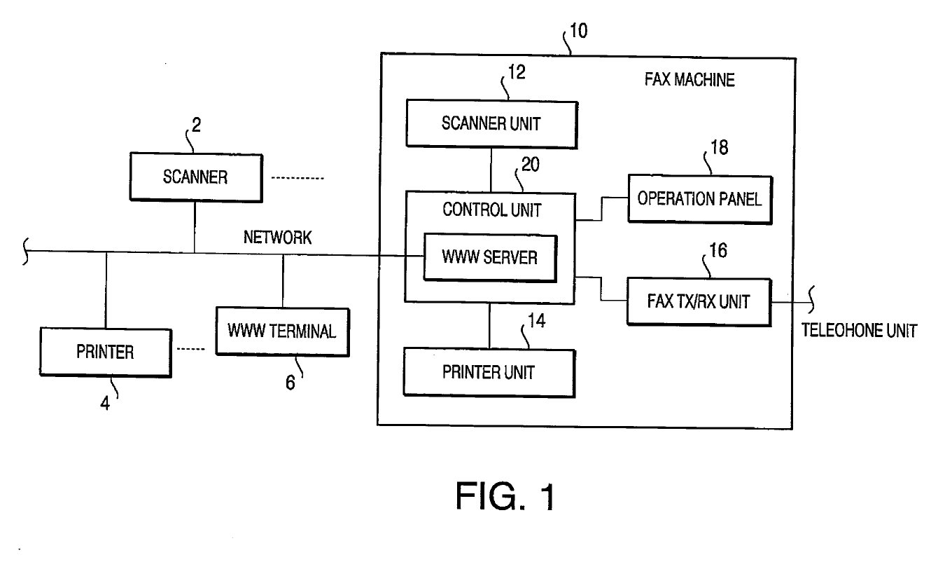

FIG. 1 is a block diagram showing the overall composition of a network system in accordance with an embodiment of the present invention. As shown in FIG. 1, the network system of this embodiment is formed by connecting a plurality of scanners 2 of different specifications (specifically, image input processing capabilities), a plurality of printers 4 of different specifications (specifically, image output processing capabilities), a WWW (World Wide Web) terminal 6 (capable of acquiring data from a WWW server and displaying the acquired data) and a FAX machine 10 (capable of controlling the scanners 2 and the printers 4 via a network) to a network constructed in a particular facility (e.g. intracompany LAN).

As shown in FIG. 1, the FAX machine 10 includes a scanner unit 12 which scans an image on a sheet (e.g. paper) and thereby generates image data similarly to the scanner 2, a printer unit 14 which forms (prints) an image on a sheet according to image data similarly to the printer 4, a FAX transmission/reception unit 16 which transmits and receives facsimile data (image data) via a telephone line, an operation panel 18 having an operation unit (to be used for inputting phone numbers, selecting an operation mode or function of the FAX machine 10, etc.) and a display unit (for displaying menus, etc.), and a control unit 20 which controls the above components of the FAX machine 10 according to various instructions inputted through the operation panel 18.

In this embodiment, the FAX machine 10 is configured as an MFP (Multi Function Peripheral) in which the scanner unit 12, the printer unit 14 and the FAX transmission/reception unit 16 can independently be controlled by the control unit 20.

Communication methods, etc. of the scanners 2 and the printers 4 connected to the network have been standardized according to UPnP (Universal Plug and Play®) so that the devices can be controlled by the control unit 20 of the FAX machine 10 via the network.

Therefore, the control unit 20 of the FAX machine 10 is implemented as a computer having the communication function so that the control unit 20 can automatically detect and control the devices on the network by use of multicast packets (advertisement packets and search packets which will be explained later) in conformity with the technical specifications of UPnP® while also operating as a WWW server for the WWW terminal 6.

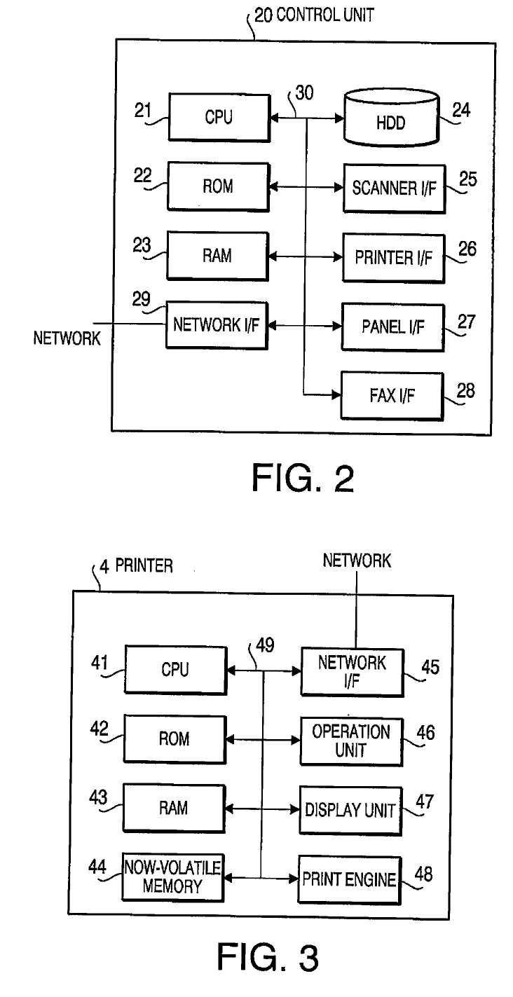

FIG. 2 is a block diagram showing the configuration of the control unit 20 of the FAX machine 10. As shown in FIG. 2, the control unit 20 includes a CPU (Central Processing Unit) 21 which executes various processes for gathering device information from the devices (scanners 2 and printers 4) and realizing integrated control of the devices, a ROM (Read Only Memory) 22 storing various programs such as a startup program (BIOS) to be executed by the CPU 21 at startup, a RAM (Random Access Memory) 23 which is used as storage areas and work areas when various processes are executed by the CPU 21, an HDD (Hard Disk Drive) 24 which stores an OS (Operating System), a server program for letting the control unit 20 function as a WWW server, gathered device information, etc., a scanner I/F (interface) 25 connecting the CPU 21 with the scanner unit 12, a printer I/F 26 connecting the CPU 21 with the printer unit 14, a panel I/F 27 connecting the CPU 21 with the operation panel 18, a FAX I/F 28 connecting the CPU 21 with the FAX transmission/reception unit 16, a network I/F 29 connecting the CPU 21 with the network, and a bus connecting the above components of the control unit 20 together.

FIG. 3 is a block diagram showing the configuration of the printer 4. As shown in FIG. 3, the printer 4 includes a CPU 41 which executes centralized control of the components of the printer 4, a ROM 42 storing various programs (for processes to be executed by the CPU 41) and device information on the printer 4 (IP address, device type, model name, print characteristics, the number of colors for printing, etc.), a RAM 43 which is used as storage areas and work areas when various processes are executed by the CPU 41, a nonvolatile memory 44 which stores data generated by the CPU 41 executing various processes and records of errors occurring in the processes, a network I/F 45 connecting the CPU 41 with the network, an operation unit 46 which receives user operations (for operating the printer 4) through operation switches, a display unit 47 which displays information (printer status, etc.) according to instructions from the CPU 41, a print engine 48 which performs printing on a sheet according to instructions from the CPU 41, and a bus 49 connecting the above components of the printer 4 together.

The scanner 2 is configured similarly to the printer 4, except that a scanner unit for scanning an image on a sheet and thereby generating image data is provided instead of the print engine 48.

The WWW terminal 6 is implemented by a personal computer, for example. The WWW terminal 6 allows a user to check an output image (image to be outputted) via the network (when the control unit 20 of the FAX machine 10 executes printing of an image by use of the printer unit 14 or a printer 4 on the network) and to designate a combination of a scanner and a printer (a scanner 2 or scanner unit 12 and a printer 4 or printer unit 14 to be used by the control unit 20 for image input/output) via the network, by making access to the WWW server of the FAX machine 10 according to instructions of the user.

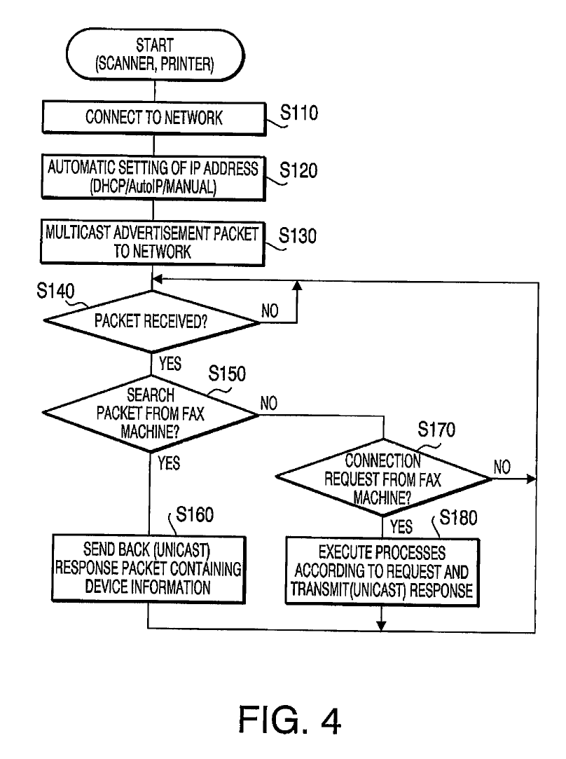

In the following, the operation of the scanners 2 and printers 4 connected to the network will be described in detail referring to FIG. 4. FIG. 4 is a flow chart showing the operation of each device (scanner 2, printer 4) connected to the network.

The process shown in FIG. 4 is executed repeatedly by the CPU 41 of each device (scanner 2, printer 4) after the device is turned ON. At the start of the process, the CPU 41 connects to the network via the network I/F 45 (S110) and executes automatic setting of an IP address of the device (S120). In the step S120, the IP address is set to an IP address determined by a DHCP (Dynamic Host Configuration Protocol) server or AutoIP, or an IP address that has been preset manually.

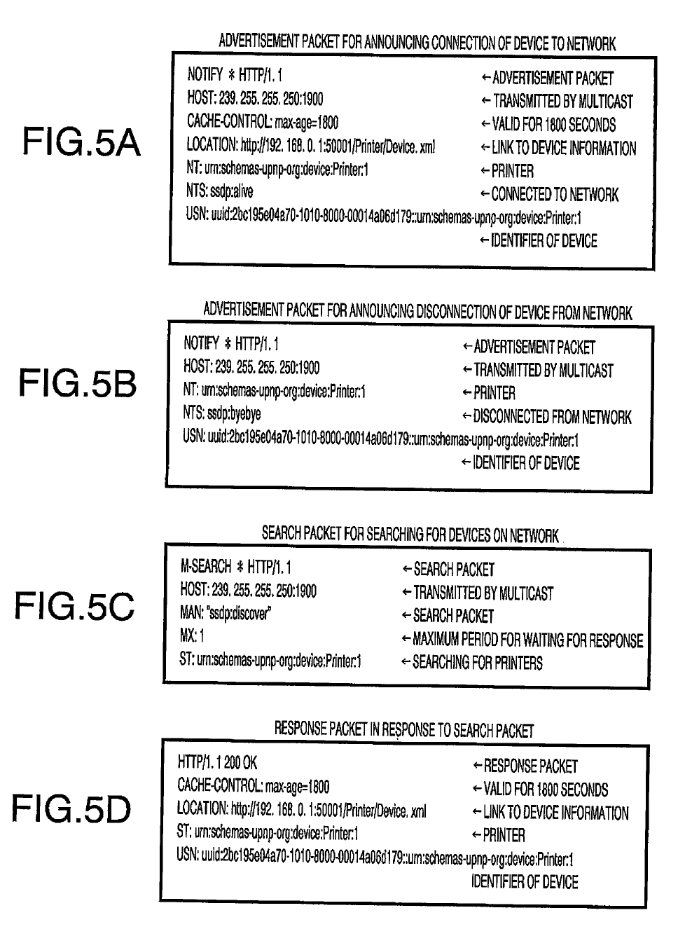

Subsequently, the CPU 41 multicasts an advertisement packet for announcing its connection to the network (see FIG. 5A) to the network (S130) and thereafter waits for a packet from another network device by checking whether such a packet has been received or not (S140).

When a packet is received (S140: YES), the CPU 41 judges whether or not the received packet is a search packet (see FIG. 5C) multicasted by the FAX machine 10 (S150). If the received packet is the search packet from the FAX machine 10 (S150: YES), the CPU 41 transmits (unicasts) a response packet containing the device information on the device (see FIG. 5D) to the FAX machine 10 (S160) and thereafter returns to the step S140.

If the received packet is not the search packet from the FAX machine 10 (S150: NO), the CPU 41 judges whether or not the received packet is a connection request from the FAX machine 10 (S170). If the received packet is not the connection request from the FAX machine 10 (S170: NO), the process returns to the step S140.

If the received packet is the connection request from the FAX machine 10 (S170: YES), the CPU 41 executes various control processes (processes corresponding to the connection request and transmission of a response to the connection request) (S180) and thereafter returns to the step S140.

Incidentally, when the power switch of the device is turned OFF or when a disconnection instruction (ordering disconnection from the network) is inputted through the operation unit 46, the CPU 41 multicasts an advertisement packet for announcing its disconnection from the network (see FIG. 5B) to the network.

FIG. 5A shows the advertisement packet multicasted by each device (scanner 2, printer 4) for announcing its connection to the network. The advertisement packet of FIG. 5A includes information indicating that the packet is an advertisement packet, information indicating that the packet is transmitted by multicast, information indicating the validity period of the packet, information indicating a link to the device information on the device, information indicating the type of the device (printer in FIG. 5A), information indicating that the device has been connected to the network, and identification information (identifier) of the device.

FIG. 5B shows the advertisement packet multicasted by each device (scanner 2, printer 4) for announcing its disconnection from the network. The advertisement packet of FIG. 5B includes information indicating that the packet is an advertisement packet, information indicating that the packet is transmitted by multicast, information indicating the type of the device (printer in FIG. 5B), information indicating that the device is disconnecting from the network, and identification information (identifier) of the device.

FIG. 5C shows the search packet multicasted by the FAX machine 10 for searching for devices on the network. The search packet of FIG. 5C includes information indicating that the packet is a search packet, information indicating that the packet is transmitted by multicast, information indicating that the packet is a search packet, information indicating the maximum period for waiting for the response, and information indicating the type of devices searched for (printer in FIG. 5C).

FIG. 5D shows the response packet transmitted (unicasted) by a device receiving the search packet of FIG. 5C for informing the FAX machine 10 about the device information on the device. The response packet of FIG. 5D includes information indicating that the packet is a response packet, information indicating the validity period of the packet, information indicating a link to the device information on the device, and identification information (identifier) of the device.

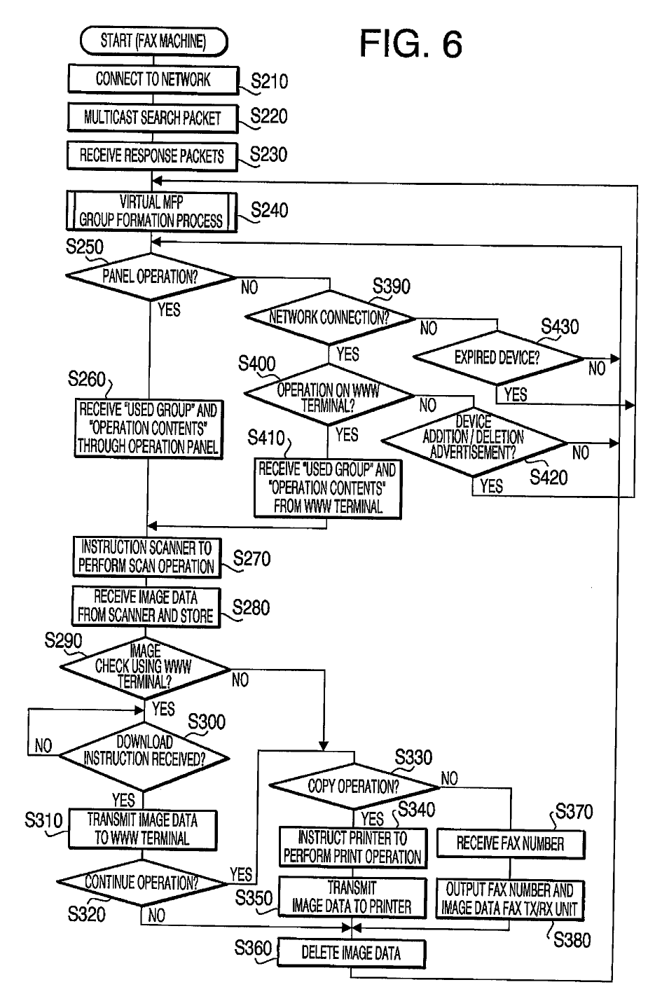

FIG. 6 is a flow chart showing a process executed by (the CPU 21 of) the control unit 20 of the FAX machine 10.

The process shown in FIG. 6 is executed repeatedly by the CPU 21 of the FAX machine 10 after the FAX machine 10 is turned ON. At the start of the process, the CPU 21 connects to the network via the network I/F 29 (S210).

Subsequently, the CPU 21 multicasts the aforementioned search packet (see FIG. 5C) to devices (scanners 2, printers 4) on the network (S220) and receives response packets (see FIG. 5D) returned from the devices in response to the search packet (S230), by which identification information of the devices and links to the device information on the devices are acquired from the devices (scanners 2, printers 4) on the network.

Upon reception of the response packet from each device (scanner 2, printer 4) on the network, the CPU 21 acquires device information on the device and attribute information (indicating processing capabilities of the device) from the link to the device information contained in the response packet. Based on the acquired attribute information on the devices on the network, the CPU 21 sets a combination of a scanner 2 and a printer 4 of equivalent image processing capabilities for each purpose of the input image supplied from the scanner 2 and thereby forms a group of devices (“virtual MFP group” including a scanner 2 and a printer 4) to be operated as an MFP (Multi Function Peripheral) for each purpose (S240).

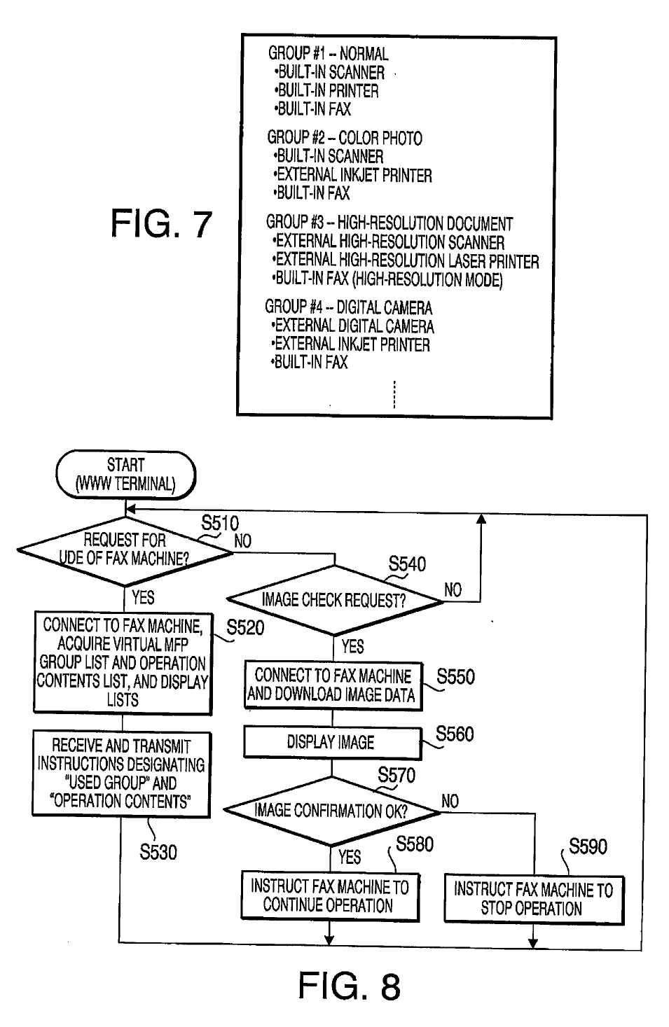

In the virtual MFP group formation process (S240), the virtual MFP group is formed for each purpose of an image (that can be acquired from the scanner 2 or the scanner unit 12), by selecting a combination of a scanner 2 (or scanner unit 12) and a printer 4 (or printer unit 14) to be used for image input/output. FIG. 7 shows an example of the result of the virtual MFP group formation process. In the example of FIG. 7, the scanner unit 12, the printer unit 14 and the FAX transmission/reception unit 16 built in the FAX machine 10 have been selected as a group #1 for monochrome images (as a standard group for normal image input/output). As a group #2 suitable for input/output of color photos, the scanner unit 12 built in the FAX machine 10, an inkjet printer selected from the printers 4 on the network, and the FAX transmission/reception unit 16 built in the FAX machine 10 have been selected. As a group #3 suitable for high-resolution input/output of documents, a high-resolution scanner selected from the scanners 2 on the network, a high-resolution laser printer selected from the printers 4 on the network, and the FAX transmission/reception unit 16 built in the FAX machine 10 (high-resolution mode) have been selected.

While the details of the virtual MFP group formation process (S240) will be explained later, when a digital camera (an image input device other than the scanners 2) is connected to the network, the digital camera, an inkjet printer selected from the printers 4 on the network (as a printer suitable for outputting (printing) input images from the digital camera), and the FAX transmission/reception unit 16 built in the FAX machine 10 are selected as a group #4 for digital cameras, as shown in FIG. 7.

The virtual MFP groups formed by the virtual MFP group formation process (S240) are displayed on the display of the operation panel 18 of the FAX machine 10 in a list format like the one shown in FIG. 7.

After forming the virtual MFP groups (S240), the CPU 21 checks whether or not the operation panel 18 has been operated by the user (S250). If the operation panel 18 has been operated (S250: YES), the CPU 21 receives instructions of the user operating the operation panel 18 for designating a “used group” (selected from the displayed virtual MFP groups) and “operation contents” (copy or FAX, whether to execute an image check or not, etc.) through the operation panel 18 (S260).

After receiving the user's instructions (S260), the CPU 21 instructs the scanner 2 (or scanner unit 12) included in the virtual MFP group designated by the user to perform a scan operation (S270). Subsequently, the CPU 21 receives image data transmitted from the scanner 2 (or scanner unit 12) and stores the received image data in the HDD 24 (S280). Incidentally, the WWW server of the FAX machine 10 is used for the reception of image data from a scanner 2. Each scanner 2 is configured to transmit image data (generated by scanning an image on a sheet) according to HTTP.

Subsequently, the CPU 21 checks whether or not the image check (using the WWW terminal 6) has been specified in the “operation contents” designated by the user (S290). If the image check using the WWW terminal 6 has been specified in the “operation contents” (S290: YES), the CPU 21 waits for an image data download instruction from the WWW terminal 6 by checking whether the image data download instruction has been received or not (as an unshown WWW server process) (S300).

Upon reception of the image data download instruction from the WWW terminal 6 (S300: YES), the CPU 21 transmits the image data stored in the HDD 24 in S280 to the WWW terminal 6 via the WWW server according to HTTP (S310). The user operating the WWW terminal 6 checks the image data displayed on a screen and designates whether or not to continue the ongoing operation (copy operation or FAX transmission operation). Thus, the CPU 21 checks whether or not an operation continuation instruction has been received from the WWW terminal 6 (as the WWW server process) (S320).

If the operation continuation instruction has been received (S320: YES), the CPU 21 checks whether or not the copy operation or the FAX transmission operation has been specified in the “operation contents” designated by the user (S330). If the copy operation has been specified in the “operation contents” (S330: YES), the CPU 21 instructs the printer 4 (or printer unit 14) included in the virtual MFP group designated by the user to perform a print operation (S340) and transmits the image data to the printer 4 (or printer unit 14) (S350).

On the other hand, if the FAX transmission operation has been specified in the “operation contents” (S330: NO), the CPU 21 receives a FAX number (phone number of a FAX machine as the destination of the image data) from the user (S370) and outputs the FAX number and the image data to the FAX transmission/reception unit 16 (S380), by which the image data is transmitted to the FAX machine having the FAX number designated by the user.

After transmitting the image data to a printer 4 (or printer unit 14) or an external FAX machine as above, the CPU 21 deletes the image data from the HDD 24 (S360) and thereafter returns to the step S250.

In the step S250, if the operation panel 18 has not been operated (S250: NO), the CPU 21 checks whether or not an external device has been connected via the network (S390). If an external device has been connected via the network (S390: YES), the CPU 21 judges whether or not the connection of the external device was caused by a user operation on the WWW terminal 6 (S400).

If the connection of the external device was caused by a user operation on the WWW terminal 6 (S400: YES), the CPU 21 receives instructions of the user operating the WWW terminal 6 for designating a “used group” (selected from a plurality of virtual MFP groups) and “operation contents” (copy or FAX, whether to execute an image check or not, etc.) through the WWW terminal 6, the network and the WWW server (S410) and thereafter advances to the step S270. Incidentally, for implementing the step S410, the CPU 21 transmits the list of virtual MFP groups (virtual MFP group list, see FIG. 7) and a list of available operations (operation contents list) to the WWW terminal 6 via the WWW server.

On the other hand, if the connection of the external device was not caused by a user operation on the WWW terminal 6 (S400: NO), the CPU 21 judges whether or not the connection of the external device was caused by transmission of an advertisement packet by a device (scanner 2, printer 4) on the network for announcing addition or deletion (connection or disconnection) of the device, that is, the CPU 21 judges whether an advertisement packet has been received or not (S420). If an advertisement packet has been received (S420: YES), the process returns to the step S240. If no advertisement packet has been received (S420: NO) the process returns to the step S250.

In the step S390, if no external device has been connected via the network (S390: NO), the CPU 21 judges whether or not the scanners 2 and printers 4 currently recognized on the network include an expired device (scanner 2, printer 4) whose validity period (specified in the advertisement packet from the device) has expired (S430).

Specifically, each device (scanner 2, printer 4) connected to the network is configured to transmit the advertisement packet having a particular validity period (e.g. 1800 seconds) at predetermined cycles shorter than the validity period. In the step S430, the CPU 21 judges whether or not there exists an expired device whose elapsed time since the reception of the advertisement packet exceeds the validity period. If there exists an expired device, the CPU 21 judges that the device has disconnected from the network and thus returns to the step S240. If there exists no expired device, the CPU 21 returns to the step S250.

FIG. 8 is a flow chart showing a process executed by the WWW terminal 6 (implemented by a personal computer, for example) when a user of the WWW terminal 6 uses the FAX machine 10 or previously checks an output image of the FAX machine 10.

The process shown in FIG. 8 is executed repeatedly by (a CPU of) the WWW terminal 6 after the WWW terminal 6 is turned ON. At the start of the process, the WWW terminal 6 checks whether or not a request for the use of the FAX machine 10 has been inputted by the user (S510).

If the request for the use of the FAX machine 10 has been inputted (S510: YES), the WWW terminal 6 connects to the WWW server of the FAX machine 10, acquires the aforementioned virtual MFP group list and operation contents list, and displays the acquired lists on an unshown display device (S520).

Subsequently, the WWW terminal 6 receives instructions of the user operating the WWW terminal 6 for designating a “used group” and “operation contents”, transmits the instructions (designating the “used group” and the “operation contents”) to the WWW server of the FAX machine 10 (S530), and thereafter returns to the step S510.

On the other hand, if the request for the use of the FAX machine 10 has not been inputted (S510: NO), the WWW terminal 6 checks whether or not an image check request requesting the image check has been inputted by the user (S540).

If the image check request has been inputted (S540: YES), the WWW terminal 6 connects to the WWW server of the FAX machine 10, downloads the image data (before printing or FAX transmission) from the WWW server (S550), and displays an image on the display device according to the downloaded image data (S560).

After a while, the WWW terminal 6 checks whether or not the user checking the image has pressed a confirmation button (OK button) (S570). If the user has pressed the OK button (S570: YES), the WWW terminal 6 instructs the FAX machine 10 to continue the ongoing operation (S580) and thereafter returns to the step S510. On the other hand, if the user has not pressed the OK button (or if the user noticing abnormality in the image has pressed a cancel button) (S570: NO), the WWW terminal 6 instructs the FAX machine 10 to stop the ongoing operation (S590) and thereafter returns to the step S510.

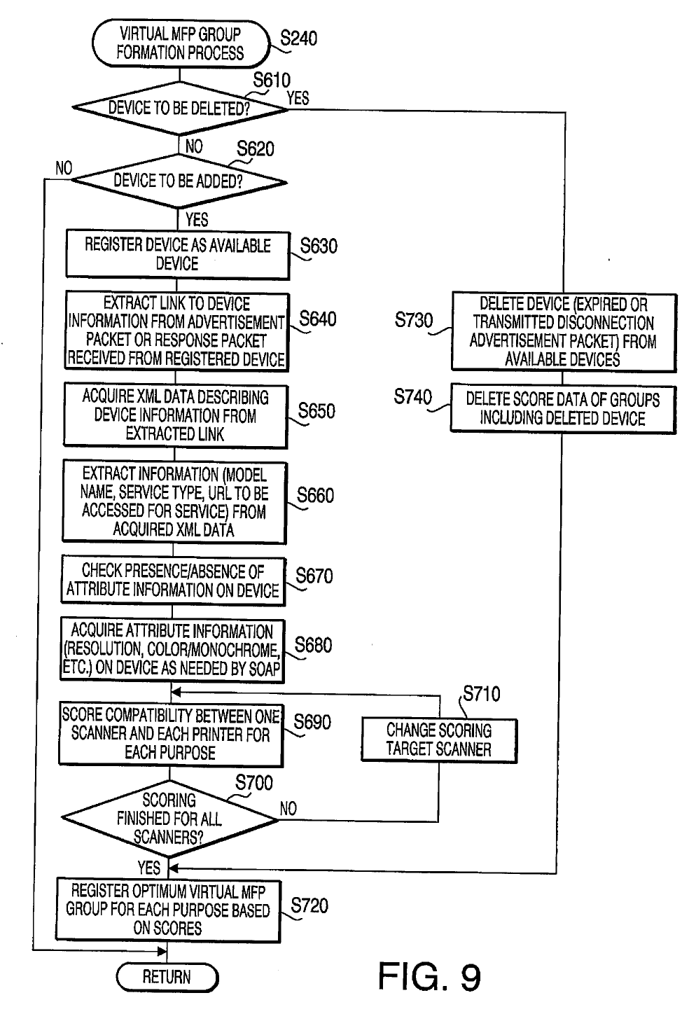

FIG. 9 is a flow chart showing the virtual MFP group formation process (S240 in FIG. 6) executed by (the CPU 21 of) the control unit 20 of the FAX machine 10.

At the start of the virtual MFP group formation process, the CPU 21 judges whether or not the devices (scanners 2 and printers 4) currently recognized on the network include a device that should be deleted, that is, a device that has transmitted the advertisement packet announcing the disconnection from the network or that is judged to have expired based on the validity period specified in the advertisement packet announcing the connection to the network (S610).

If there is no device that should be deleted (S610: NO), the CPU 21 judges whether or not there is a device (scanner 2, printer 4) that should be added as a device connected to the network, that is, whether or not devices (scanners 2 and printers 4) that are regarded to be already connected to the network based on the response packets and advertisement packets include a yet unregistered device (S620).

If there is no device that should be added (S620: NO), the CPU 21 ends the virtual MFP group formation process of FIG. 9. If there is a device that should be added (S620: YES), the CPU 21 registers the device (that should be added) in the HDD 24 as an available device (S630) and extracts the link to the device information from the advertisement packet or response packet (see FIGS. 5A and 5D) received from the registered device (S640).

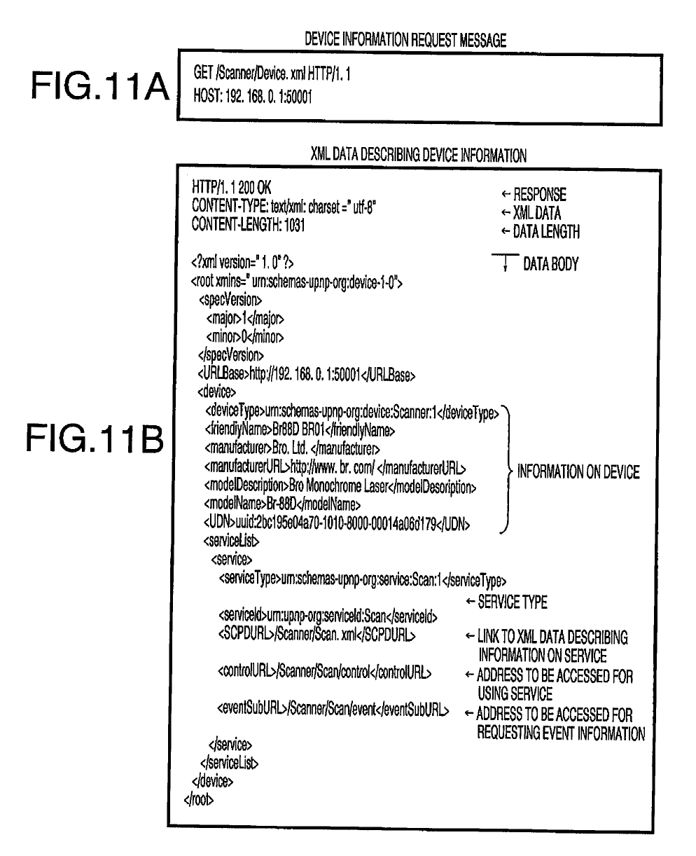

After extracting the link (URL) to the device information (S640), the CPU 21 transmits a device information request message (see FIG. 11A) to the extracted link, acquires XML data describing the device information in detail (see FIG. 11B) from the link (S650), and extracts necessary information (model name of the device, type of service, address (URL) to be accessed for the service, etc.) from the acquired XML data (S660).

Subsequently, the CPU 21 searches the HDD 24 and thereby checks whether or not the aforementioned attribute information (indicating the processing capabilities) on the device specified from the XML data acquired in S650 has already been stored in the HDD 24 (S670).

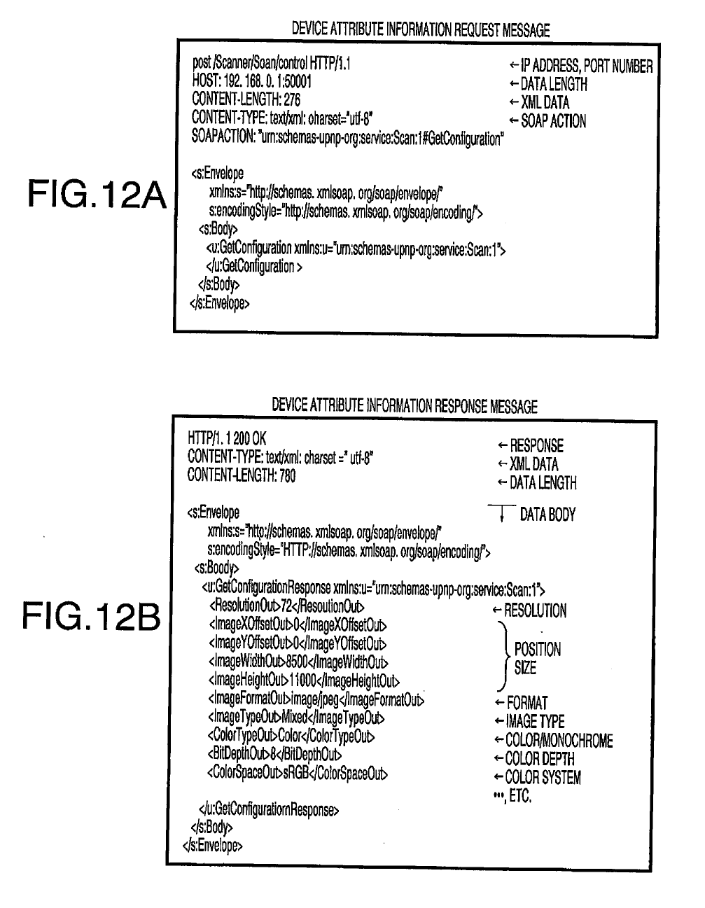

If the attribute information on the device specified from the XML data acquired in S650 has not been stored in the HDD 24 yet (S670: NO), the CPU 21 extracts a link (IP address, port number) to XML data describing the attribute information on the device from the XML data of the device acquired in S650, transmits a device attribute information request message (see FIG. 12A) to the extracted link according to SOAP (Simple Object Access Protocol) which employs XML for the description of contents of communication, and thereby acquires a device attribute information response message (see FIG. 12B) (S680).

By the step S680, the CPU 21 can recognize the resolution, image size, image format, image type, color/monochrome, color depth, color system, etc. regarding images that can be processed by the device (scanner 2, printer 4) on the network (see FIG. 12B),

After acquiring the attribute information on the newly registered device (S680), the CPU 21 scores (evaluates) compatibility or equivalence between a scanner 2 (or scanner unit 12) available for the virtual MFP and each printer 4 (or printer unit 14) available for the virtual MFP, for each image purpose (S690).

Subsequently, the CPU 21 checks whether or not the scoring of the step S690 has been finished for all the scanners 2 (and the scanner unit 12) available for the virtual MFP, that is, whether or not the scoring of the compatibility between a scanner and a printer has been finished for all the scanners 2 (and the scanner unit 12) and the printers 4 (and the printer unit 14) available for the virtual MFP (S700). If the scoring of the step S690 has not been finished for all the scanners 2 (and the scanner unit 12) (S700: NO), the CPU 21 changes the scoring target scanner to another scanner 2 (or scanner unit 12) before being scored (S710) and executes the scoring step S690 again for the new scoring target scanner.

On the other hand, if the scoring step S690 has been finished for all the scanners 2 (and the scanner unit 12) available for the virtual MFP (S700: YES), the CPU 21 selects a combination of a scanner 2 (or scanner unit 12) and a printer 4 (or printer unit 14) achieving the highest score among all the results (score data) of the scoring process of S690 for each purpose of an image that can be inputted and outputted, registers the selected combination in the HDD 24 as the optimum virtual MFP group for each purpose (S720), and ends the virtual MFP group formation process of FIG. 9.

In the step S610, if there is a device that should be deleted (S610: YES), the CPU 21 deletes the device (which has expired or which has transmitted the advertisement packet announcing the disconnection from the network) from the available devices registered in the HDD 24 (S730), deletes score data of groups including the deleted device from the whole score data obtained by the scoring process of S690 (S740), and thereafter advances to the step S720.

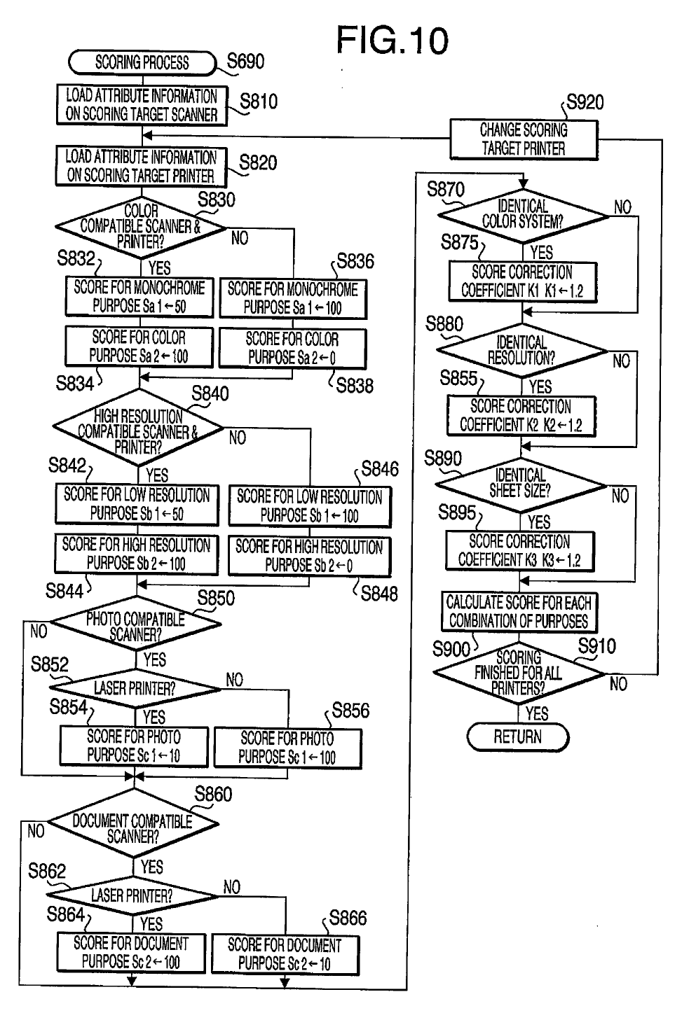

FIG. 10 is a flow chart showing a concrete example of the scoring process executed in the step S690 of FIG. 9.

At the start of the scoring process (FIG. 10), the CPU 21 loads the attribute information on the scoring target scanner (a scanner 2 or scanner unit 12 as the target of the scoring) (S810) and also loads the attribute information on a scoring target printer (a printer 4 or printer unit 14 as the target of the scoring) (S820).

Subsequently, the CPU 21 judges whether or not both the scoring target scanner and the scoring target printer are color compatible (i.e. supporting colors) based on the loaded attribute information (S830). If both the scoring target scanner and printer are color compatible (S830: YES), the CPU 21 sets a score “Sa1” (regarding the use of the scoring target scanner and printer for a monochrome purpose (monochrome scanning and printing)) at 50 points, for example (S832) while setting a score “Sa2” (regarding the use of the scoring target scanner and printer for a color purpose (color scanning and printing)) at 100 points, for example (S834).

On the other hand, if either the scoring target scanner or the scoring target printer is color incompatible, that is, for monochrome use (S830: NO), the CPU 21 sets the score “Sa1” (regarding the use of the scoring target scanner and printer for the monochrome purpose) at 100 points, for example (S836) while setting the score “Sa2” (regarding the use of the scoring target scanner and printer for the color purpose) at 0 points, for example (S838).

In short, in the steps S830-S838, the score “Sa1” (regarding the use of the scoring target scanner and printer for the monochrome purpose) and the score “Sa2” (regarding the use of the scoring target scanner and printer for the color purpose) are set based on whether the scoring target scanner and printer are color compatible or not. Incidentally, each score is set higher as the suitability of the combination of the scoring target scanner and printer for each purpose gets higher.

After setting the score “Sa1” (for the monochrome purpose) and the score “Sa2” (for the color purpose) of the scoring target scanner and printer as above, the CPU 21 judges whether or not both the scoring target scanner and printer are high resolution compatible based on the attribute information on the scoring target scanner and printer (S840).

If both the scoring target scanner and printer are high resolution compatible (S840: YES), the CPU 21 sets a score “Sb1” (regarding the use of the scoring target scanner and printer for a low resolution purpose) at 50 points, for example (S842) while setting a score “Sb2” (regarding the use of the scoring target scanner and printer for a high resolution purpose) at 100 points, for example (S844).

On the other hand, if either the scoring target scanner or the scoring target printer is high resolution incompatible, that is, for low resolution use (S840: NO), the CPU 21 sets the score “Sb1” (regarding the use of the scoring target scanner and printer for the low resolution purpose) at 100 points, for example (S846) while setting the score “Sb2” (regarding the use of the scoring target scanner and printer for the high resolution purpose) at 0 points, for example (S848).

In short, in the steps S840-S848, the score “Sb1” (regarding the use of the scoring target scanner and printer for the low resolution purpose) and the score “Sb2” (regarding the use of the scoring target scanner and printer for the high resolution purpose) are set based on whether the scoring target scanner and printer are high resolution compatible or not.

After setting the score “Sb1” (for the low resolution purpose) and the score “Sb2” (for the high resolution purpose) of the scoring target scanner and printer as above, the CPU 21 judges whether the scoring target scanner is photo compatible or not based on the attribute information on the scoring target scanner (S850).

If the scoring target scanner is photo compatible (S850: YES), the CPU 21 judges whether the scoring target printer is a laser printer or not based on the attribute information on the scoring target printer (S852). If the scoring target printer is a laser printer (S852: YES), the CPU 21 sets a score “Sc1” (regarding the use of the scoring target scanner and printer for a photo purpose) at 10 points, for example (S854). If the scoring target printer is not a laser printer (S852: NO), the CPU 21 sets the score “Sc1” (regarding the use of the scoring target scanner and printer for the photo purpose) at 100 points, for example (S856).

On the other hand, if the scoring target scanner is photo incompatible (S850: NO), the CPU 21 advances to step S860 without setting the score “Sc1” for the photo purpose (i.e. Sc1=0). Also when the score “Sc1” for the photo purpose is set (S854, S856), the process advances to the step S860.

In the step S860, the CPU 21 judges whether the scoring target scanner is document compatible or not based on the attribute information on the scoring target scanner.

If the scoring target scanner is document compatible (S860: YES), the CPU 21 judges whether the scoring target printer is a laser printer or not based on the attribute information on the scoring target printer (S862).

If the scoring target printer is a laser printer (S862: YES), the CPU 21 sets a score “Sc2” (regarding the use of the scoring target scanner and printer for a document purpose) at 100 points, for example (S864). If the scoring target printer is not a laser printer (S862: NO), the CPU 21 sets the score “Sc2” (regarding the use of the scoring target scanner and printer for the document purpose) at 10 points, for example (S866).

On the other hand, if the scoring target scanner is document incompatible (S860: NO), the CPU 21 advances to step S870 without setting the score “Sc2” for the document purpose (i.e. Sc2=0). Also when the score “Sc2” for the document purpose is set (S864, S866), the process advances to the step S870.

In the step S870, the CPU 21 judges whether or not the color system of the scoring target scanner is identical with that of the scoring target printer based on the attribute information on the scoring target scanner and printer. If the color systems are identical with each other (S870: YES), the CPU 21 sets a score correction coefficient “K1” for the combination of the scoring target scanner and printer at 1.2 (S875) and advances to step S880. On the other hand, if the color systems are not identical with each other (S870: NO), the CPU 21 advances to the step S880 without setting the score correction coefficient “K1” (i.e. K1=1).

In the step S880, the CPU 21 judges whether or not the resolution of the scoring target scanner is identical with that of the scoring target printer based on the attribute information on the scoring target scanner and printer. If the resolutions are identical with each other (S880: YES), the CPU 21 sets a score correction coefficient “K2” for the combination of the scoring target scanner and printer at 1.2 (S885) and advances to step S890. On the other hand, if the resolutions are not identical with each other (S880: NO), the CPU 21 advances to the step S890 without setting the score correction coefficient “K2” (i.e. K2=1).

In the step S890, the CPU 21 judges whether or not the sheet size of the scoring target scanner is identical with that of the scoring target printer based on the attribute information on the scoring target scanner and printer. If the sheet sizes are identical with each other (S890: YES), the CPU 21 sets a score correction coefficient “K3” for the combination of the scoring target scanner and printer at 1.2 (S895) and advances to step S900. On the other hand, if the sheet sizes are not identical with each other (S890: NO), the CPU 21 advances to the step S900 without setting the score correction coefficient “K3” (i.e. K3=1).

In the step S900, the CPU 21 calculates the score (total score) of the combination of the scoring target scanner and printer for each combination of purposes, by use of the scores Sa1-Sc2 for the above purposes and the score correction coefficients K1-K3.

For example, a score regarding the use of the scoring target scanner and printer for a high resolution color photo purpose is calculated by adding the score Sa2 for the color purpose, the score Sb2 for the high resolution purpose and the score Sc1 for the photo purpose together and multiplying the sum by the product of the score correction coefficients K1-K3. A score regarding the use of the scoring target scanner and printer for a high resolution monochrome photo purpose is calculated by adding the score Sa1 for the monochrome purpose, the score Sb2 for the high resolution purpose and the score Sc1 for the photo purpose together and multiplying the sum by the product of the score correction coefficients K1-K3. A score regarding the use of the scoring target scanner and printer for a high resolution color document purpose is calculated by adding the score Sa2 for the color purpose, the score Sb2 for the high resolution purpose and the score Sc2 for the document purpose together and multiplying the sum by the product of the score correction coefficients K1-K3.

After calculating the score of the scoring target scanner and printer for each combination of purposes as above (S900), the CPU 21 checks whether or not the above scoring routine (S820-S900) has been executed for all the printers 4 and the printer unit 14 (S910).

If the above scoring routine has been executed for all the printers 4 and the printer unit 14 (S910: YES), the scoring process of FIG. 10 is ended. If the above scoring routine has not been executed for all the printers 4 and the printer unit 14 yet (S910: NO), the CPU 21 changes the scoring target printer to another printer 4 (or printer unit 14) before being scored (S920) and executes the scoring routine (S820-S900) again for the new scoring target printer.

As described above, in the network system in accordance with the embodiment of the present invention, the control unit 20 of the FAX machine 10 (image input/output control device) acquires attribute information regarding image input processing capabilities from each scanner 2 (image input device connected to the network) and attribute information regarding image output processing capabilities from each printer 4 (image output device connected to the network), calculates a score regarding the use of each combination of a scanner 2 (or scanner unit 12) and a printer 4 (or printer unit 14) for each purpose (combination of purposes) based on the acquired attribute information, selects a combination of a scanner 2 (or scanner unit 12) and a printer 4 (or printer unit 14) achieving the highest score in regard to each purpose (combination of purposes), and presents (displays) the selected combination to the user as the “virtual MFP group” in regard to each purpose (combination of purposes).

Therefore, the user is allowed to easily designate a scanner (scanner 2 or scanner unit 12) and a printer (printer 4 or printer unit 14) that are the most suitable for the input/output (copying) of an image of a particular image type only by selecting a desired virtual MFP group (combination) from the presented virtual MFP groups depending on the type of the image. Thus, the user is prevented from erroneously selecting a printer unsuitable for outputting (printing) the input image from the scanner.

The control unit 20, built in the FAX machine 10 for controlling the scanners 2 and the printers 4 on the network, is configured to allow the selection of the scanner unit 12 and/or the printer unit 14 (built in the FAX machine 10) as a component of the virtual MFP group, and to also allow the selection of the FAX transmission/reception unit 16 as the image output device for outputting the input image from a scanner 2 or scanner unit 12. Therefore, the input image obtained (by image scanning) by a scanner 2 on the network or the scanner unit 12 of the FAX machine 10 can also be transmitted to an external FAX machine connected to the FAX machine 10 via a telephone line, by which the functions and usability of the FAX machine 10 are enhanced considerably.

The control unit 20 is configured to function also as a WWW server. In the acquisition of image data from a scanner 2 on the network and in the transmission of the image data to a printer 4 or the WWW terminal 6 on the network, the image data is received and transmitted according to HTTP by use of the WWW server. By the communication of image data among a scanner 2 on the network, the WWW server and a printer 4 on the network (and the WWW terminal 6) according to a common protocol, these devices can be operated as one image input/output device.

The control unit 20 in this embodiment automatically detects the scanners 2 and printers 4 on the network by use of the search packets and advertisement packets according to UPnP® and automatically acquires the detailed device information and attribute information on the devices on the network. Therefore, the control unit 20 is capable of automatically forming the virtual MFP groups upon its connection to the network, by which the usability of the system is enhanced remarkably.

The user is allowed to check the image data (generated by image scanning by a scanner 2 or the scanner unit 12) by use of the WWW terminal 6 before the execution of the printing or FAX transmission. Therefore, even when the image data has not been generated successfully (due to a scanning error of the scanner 2 or scanner unit 12, etc.), the user is prevented from executing the printing or FAX transmission of the erroneous image data.

While a description has been given above of a preferred embodiment in accordance with the present invention, the present invention is not to be restricted by the particular illustrative embodiment and a variety of modifications, design changes, etc. are possible without departing from the scope and spirit of the present invention described in the appended claims.

For example, while the functions of the image input/output control device are implemented by the control unit 20 of the FAX machine 10 in the above embodiment, the functions may also be implemented by a server designed and provided specifically for the functions.

While the network system in the above embodiment includes a plurality of scanners available for the virtual MFP group, the present invention is also applicable and similar effects can be achieved even when the network system includes only one scanner for image input.

While the control unit 20 of the FAX machine 10 (image input/output control device) selects a combination of an image input device (scanner 2 or scanner unit 12) and an image output device (printer 4 or printer unit 14) achieving the highest score as the virtual MFP group (in regard to each purpose (combination of purposes)) in the above embodiment, the control unit 20 may also be configured to select a plurality of (e.g. top three) virtual MFP groups (in regard to each purpose) based on the scores obtained by the scoring process of FIG. 10, display the selected virtual MFP groups on the operation panel 18 (in regard to each purpose), and let the user select one of the virtual MFP groups to be used for image input and output.

What is claimed is:

1. An image input/output control device which is connected to a network to which a plurality of image input devices of different processing capabilities and a plurality of image output devices of different processing capabilities are connected, for selectively combining one of the image input devices with one of the image output devices and operating the combined image input device and image output device as one image input/output device, comprising:
a first acquisition unit which acquires information on image input processing capabilities of each image input device from each image input device via the network;
a second acquisition unit which acquires information on image output processing capabilities of each image output device from each image output device via the network;
a selection unit which selects an image input device and an image output device of equivalent image input/output processing capabilities based on the information on the processing capabilities of each image input device acquired by the first acquisition unit and the information on the processing capabilities of each image output device acquired by the second acquisition unit; and
a control unit which operates the image input device and the image output device selected by the selection unit via the network as one image input/output device.

2. The image input/output control device according to claim 1, further comprising a server unit which operates as a WWW server on the network, wherein:
the control unit receives image data from the image input device selected by the selection unit according to HTTP by use of the server unit and transmits the received image data to the image output device selected by the selection unit according to HTTP by use of the server unit.

3. The image input/output control device according to claim 1, further comprising a device information acquisition unit which acquires device information on each image input device and each image output device connected to the network by use of a multicast packet requesting the device information, wherein:
the first acquisition unit and the second acquisition unit recognize the number of image input devices connected to the network, the number of image output devices connected to the network, and the processing capabilities of each image input device and each image output device based on the device information acquired by the device information acquisition unit.

4. The image input/output control device according to claim 1, wherein:
the selection unit sets a plurality of groups each of which is formed by an image input device and an image output device of equivalent image input/output processing capabilities and lets a user select one of the groups; and
the control unit operates the image input device and the image output device forming the selected group as one image input/output device.

5. The image input/output control device according to claim 1, wherein:
the first acquisition unit acquires the information on the image input processing capabilities of each image input device in regard to each of a plurality of purposes of image data, and
the second acquisition unit acquires the information on the image output processing capabilities of each image output device in regard to each of the purposes, and
the selection unit makes the selection of an image input device and an image output device of equivalent image input/output processing capabilities in regard to each of the purposes based on the information on the processing capabilities of each image input device acquired by the first acquisition unit in regard to each of the purposes and the information on the processing capabilities of each image output device acquired by the second acquisition unit in regard to each of the purposes.

6. The image input/output control device according to claim 1, further comprising at least one of an image input device and an image output device built in the image input/output control device.

7. The image input/output control device according to claim 1, wherein the control unit transmits image data acquired from the image input device to a terminal device which is connected to the network and capable of displaying images, according to an instruction from outside to let the terminal device display an image according to the image data.

8. The image input/output control device according to claim 1, further comprising a transmission unit which transmits image data to an external receiving terminal via an external network, wherein:
the control unit transmits image data acquired from the image input device to an external receiving terminal via the transmission unit according to an instruction from outside.

9. An image input/output control device which is connected to a network to which at least one image input device having a plurality of purposes of image data and a plurality of image output devices of different processing capabilities are connected, for selectively combining the at least one image input device with one of the image output devices and operating the combined image input device and image output device as one image input/output device, comprising;
a first acquisition unit which acquires information on processing capabilities of the at least one image input device in regard to each of a plurality of purposes of image data;
a second acquisition unit which acquires information on processing capabilities of each image output device;
a selection unit which selects an image input device and an image output device of equivalent image input/output processing capabilities in regard to each of the purposes based on the information on the processing-capabilities of the at least one image input device acquired by the first acquisition unit in regard to each of the purposes and the information on the processing capabilities of each image output device acquired by the second acquisition unit; and
a control unit which operates the image input device and the image output device selected by the selection unit via the network as one image input/output device.

10. The image input/output control device according to claim 9, further comprising a server unit which operates as a WWW server on the network, wherein:
the control unit receives image data from the image input device selected by the selection unit according to HTTP by use of the server unit and transmits the received image data to the image output device selected by the selection unit according to HTTP by use of the server unit.

11. The image input/output control device according to claim 9, wherein:
the at least one image input device comprises a plurality of image input devices;
the image input/output control device further comprises a device information acquisition unit which acquires device information on each image input device and each image output device connected to the network by use of a multicast packet requesting the device information; and
the first acquisition unit and the second acquisition unit recognize the number of image input devices connected to the network, the number of image output devices connected to the network, and the processing capabilities of each image input device and each image output device based on the device information acquired by the device information acquisition unit.

12. The image input/output control device according to claim 9, wherein:
the at least one image input device comprises a plurality of image input devices;
the selection unit sets a plurality of groups, each of which is formed by an image input device and an image output device of equivalent image input/output processing capabilities, in regard to each of the purposes and lets a user select one of the groups; and
the control unit operates the image input device and the image output device forming the selected group as one image input/output device.

13. The image input/output control device according to claim 9, further comprising at least one of an image input device and an image output device built in the image input/output control device.

14. The image input/output control device according to claim 9, wherein the control unit transmits image data acquired from the at least one image input device to a terminal device which is connected to the network and capable of displaying images, according to an instruction from outside to let the terminal device display an image according to the image data.

15. The image input/output control device according to claim 9, further comprising a transmission unit which transmits image data to an external receiving terminal via an external network, wherein:
the control unit transmits image data acquired from the at least one image input device to an external receiving terminal via the transmission unit according to an instruction from outside.

16. A network system comprising:
a plurality of image input devices of different processing capabilities connected to a network;
a plurality of image output devices of different processing capabilities connected to the network; and
an image input/output control device connected to the network including:
a first acquisition unit which acquires information on image input processing capabilities of each image input device from each image input device via the network;
a second acquisition unit which acquires information on image output processing capabilities of each image output device from each image output device via the network;
a selection unit which selects an image input device and an image output device of equivalent image input/output processing capabilities based on the information on the processing capabilities of each image input device acquired by the first acquisition unit and the information on the processing capabilities of each image output device acquired by the second acquisition unit; and
a control unit which operates the image input device and the image output device selected by the selection unit via the network as one image input/output device.

17. The network system according to claim 16, further comprising a terminal device which is connected to the network and capable of displaying images, wherein:
the control unit of the image input/output control device transmits image data acquired from the image input device to the terminal device according to an instruction from outside to let the terminal device display an image according to the image data.

18. The network system according to claim 16, further comprising a transmission device which is built in the image input/output control device or connected to the network and capable of transmitting image data to an external receiving terminal via an external network, wherein:
the control unit of the image input/output control device transmits image data acquired from the image input device to an external receiving terminal by use of the transmission device according to an instruction from outside.

19. A network system comprising:
at least one image input device having a plurality of purposes of image data connected to a network;
a plurality of image output devices of different processing capabilities connected to the network; and
an image input/output control device connected to the network including:
a first acquisition unit which acquires information on processing capabilities of the at least one image input device in regard to each of a plurality of purposes of image data;
a second acquisition unit which acquires information on processing capabilities of each image output device;
a selection unit which selects an image input device and an image output device of equivalent image input/output processing capabilities in regard to each of the purposes based on the information on the processing capabilities of the at least one image input device acquired by the first acquisition unit in regard to each of the purposes and the information on the processing capabilities of each image output device acquired by the second acquisition unit; and
a control unit which operates the image input device and the image output device selected by the selection unit via the network as one image input/output device.

20. The network system according to claim 19, further comprising a terminal device which is connected to the network and capable of displaying images, wherein:
the control unit of the image input/output control device transmits image data acquired from the at least one image input device to the terminal device according to an instruction from outside to let the terminal device display an image according to the image data.

21. The network system according to claim 19, further comprising a transmission device which is built in the image input/output control device or connected to the network and capable of transmitting image data to an external receiving terminal via an external network, wherein:
the control unit of the image input/output control device transmits image data acquired from the at least one image input device to an external receiving terminal by use of the transmission device according to an instruction from outside.

22. A computer program product comprising computer-readable instructions that cause a computer to function as:
a first acquisition unit which acquires information on image input processing capabilities of each image input device from each image input device connected to a network;
a second acquisition unit which acquires information on image output processing capabilities of each image output device from each image output device connected to the network;
a selection unit which selects an image input device and an image output device of equivalent image input/output processing capabilities based on the information on the processing capabilities of each image input device acquired by the first acquisition unit and the information on the processing capabilities of each image output device acquired by the second acquisition unit; and
a control unit which operates the image input device and the image output device selected by the selection unit via the network as one image input/output device.

23. A computer program product comprising computer-readable instructions that cause a computer to function as:
a first acquisition unit which acquires information on processing capabilities of at least one image input device connected to a network in regard to each of a plurality of purposes of image data;
a second acquisition unit which acquires information on processing capabilities of each image output device connected to the network;
a selection unit which selects an image input device and an image output device of equivalent image input/output processing capabilities in regard to each of the purposes based on the information on the processing capabilities of the at least one image input device acquired by the first acquisition unit in regard to each of the purposes and the information on the processing capabilities of each image output device acquired by the second acquisition unit; and
a control unit which operates the image input device and the image output device selected by the selection unit via the network as one image input/output device.
